(19) United States
(12) Patent Application Publication
(10) Pub. No.: US 2017/0218116 A1
(43) Pub. Date: Aug. 3, 2017

(54) POLYMER HAVING ADHERENCE PROPERTIES

(71) Applicant: XANCHEM, Orsay (FR)

(72) Inventors: Chakib KALAI, Paris (FR); Samir ZARD, Gif-sur-Yvette (FR); Beatrice SIRE, Palaiseau (FR)

(21) Appl. No.: 15/502,229

(22) PCT Filed: Jul. 31, 2015
(86) PCT No.: PCT/EP2015/067734

§ 371 Date: Feb. 7, 2017

(30) Foreign Application Priority Data
Aug. 8, 2014 (FR) 14 57711

(51) Int. Cl. C08G 61/12

(52) U.S. Cl. CPC C08G 61/128; C08G 61/12

(57) ABSTRACT

The present invention relates to the field of polymers used to form coatings at the surface of supports.

More particularly, the invention relates to a polymer having adhesion properties, in particular with regard to an organic or inorganic support, characterized in that it comprises at least one and preferably several consecutive or non-consecutive structural units of formula (I):

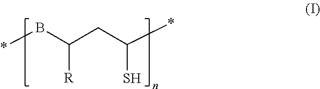

in which:
B represents a carbonyl or —NR′— unit with R′ representing a hydrogen atom, a C₁ to C₆ alkyl radical, or a C₅ to C₆ aryl, carbamate or acyl radical; and
R represents:
   a hydrogen atom,
   a linear or branched, saturated or unsaturated C₁ to C₆ hydrocarbon-based radical which, where appropriate, is substituted with one or more halogen atoms,
   a C₅ to C₆ aryl radical, or
   an acyl, acyloxy, alkoxycarbonyl or cyano radical.

The present invention relates to the field of polymers that are of use for forming coatings at the surface of supports.

A large diversity of supports are today surface-treated with a coating of polymeric nature. These coatings are usually considered for esthetic purposes, but also for the purposes of protection, in particular with regard to corrosion. Thus, substrates of metallic nature, dedicated to being in frequent contact with corrosive products, such as hydrocarbons and inorganic bases and acids, are usually surface-treated with a polymeric coating, mainly of polyamide type. These polymeric coatings are also taken advantage of for protecting fragile substrates, like for example glass, against impacts.

However, the surface coatings currently available are not entirely satisfactory, in particular in terms of adhesion.

Over time, it is common to note a localized or total loss of adhesion of this coating with, as a consequence, a fragmentation thereof. For obvious reasons, this modification of the integrity of the coating is unattractive, but may also be prejudicial in terms of protection regarding the support thus uncovered and therefore becoming vulnerable to corrosion or to mechanical impacts.

There thus remains a need for polymeric coatings having increased adhesion properties.

There also remains a need for a simple technique which is inexpensive and which makes it possible to confer, on polymers already considered for forming these coatings, improved adhesion with regard to a large diversity of supports. The objective of the present invention is precisely to meet these expectations.

### Definition of the Invention

More particularly, the inventors have developed polymers of which the polymer chain has the originality and advantage of having free thiol functions in non-end positions. The polymers according to the invention thus have the advantage of taking advantage of the high reactivity of thiol functions, and in particular of their ability to complex with certain metal atoms.

Thus, the invention describes a polymer having adhesion properties, in particular with regard to an organic or inorganic support, characterized in that it comprises at least one, preferably several, consecutive or non-consecutive structural units of formula (I):

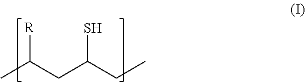

in which R represents:

a hydrogen atom,

a linear or branched, saturated or unsaturated C₁ to C₆ hydrocarbon-based radical which, where appropriate, is substituted with one or more halogen atoms,

a C₅ to C₆ aryl radical, or

an acyl, acyloxy, alkoxycarbonyl or cyano radical.

More particularly, according to a first aspect, the invention relates to a polymer having adhesion properties, in particular with regard to an organic or inorganic support, characterized in that it comprises at least one, preferably several, consecutive or nonconsecutive structural units of formula (I):

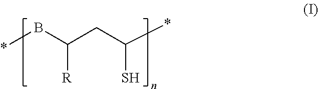

in which:

B represents a carbonyl or —NR′— unit with R′ representing a hydrogen atom, a C₁ to C₆ alkyl radical, or a C₅ to C₆ aryl, carbamate or acyl radical; and

R represents:
a hydrogen atom,
a linear or branched, saturated or unsaturated C₁ to C₆ hydrocarbon-based radical which, where appropriate, is substituted with one or more halogen atoms,
a C₅ to C₆ aryl radical, or
an acyl, acyloxy, alkoxycarbonyl or cyano radical.

Advantageously, the polymer according to the invention has an effective amount of units of formula (I) to confer thereon a tackifying property in particular with regard to a support.

With regard to the supports, or substrates, they may be of very diverse natures and may especially be inorganic, in particular metallic or of glass type or else organic, especially hydrocarbon-based or silicone-based, in particular with unsaturations or sulfhydryl units.

In particular, the polymer according to the invention partly corresponds to formula (II) or (III):

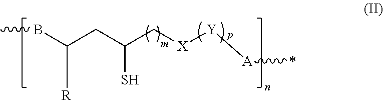

with n, m, p, R, B, A, Y and X being as defined hereinafter,

or

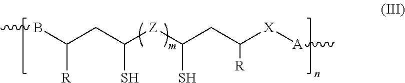

with n, m, R, B, A, X and Z being as defined hereinafter.

More advantageously, a polymer according to the invention partly corresponds to formula (IIa) or (IIIa):

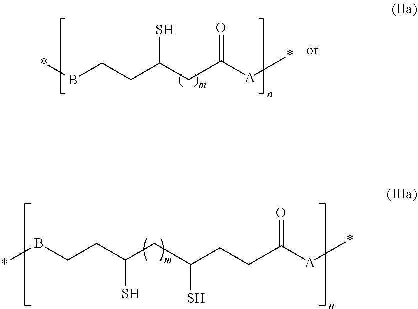

with n, m, B and A being as defined hereinafter.

In particular, a polymer according to the invention may derive from the condensation, in particular by copolymerization, of at least one entity of formula (II), (IIa), (III) or (IIa) with at least one secondary polymer chain, distinct from said entity.

More specifically, this distinct polymer chain is chosen from polyamides, polyethers, silicone-based chains, polyamines and polysulfides.

According to another of its aspects, the invention relates to a composition for coating, comprising at least one polymer according to the invention.

According to yet another of its aspects, the invention relates to a process for forming a surface coating of a support, comprising at least bringing the surface to be treated of said support into contact with a polymer according to the invention and exposing said polymer in contact with said support to conditions suitable for its conversion into a coating.

According to another of its aspects, the invention relates to a support surface-treated with a coating deriving totally or partly from a polymer according to the invention.

The invention is also directed towards a process that is useful for modulating the properties in terms of adhesion of a polymer, comprising bringing said polymer into contact with at least one precursor of an entity of formula (II), (IIa), (III) or (IIa) according to the invention in which the index “n” advantageously has a value other than 1 and preferably has a value representative of an oligomer or polymer, under conditions suitable for the condensation, and in particular the copolymerization, of said precursor with said polymer to be treated.

### DETAILED DESCRIPTION

As stated above, the level of adhesion of the polymers according to the invention is based at least partly on the presence in its polymer chain of a controlled number of SH functions which are integrated therein in the form of structural units of formula (I):

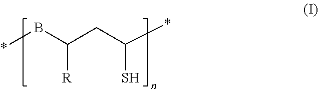

with B and R being as defined above and R preferably representing a hydrogen atom.

The various units of formula (I) present in a polymer according to the invention may or may not have R groups which may be identical or different. They are preferably identical.

Advantageously, the units of formula (I) are not present in the polymer according to the invention in a contiguous manner.

The or each unit of formula (I) may be present therein in the form of a structural entity, of optionally polymeric or oligomeric nature, advantageously condensable in particular by copolymerization.

According to a first implementation variant, a unit of formula (I) is present in the polymer according to the invention in the form of a structural entity of formula (II):

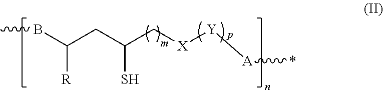

in which:

m is an integer ranging from 1 to 14 and preferably equal to 1 or 8,

p is equal to zero or 1,

n is an integer representative of an oligomeric or polymeric sequence, in particular having a MW which may range from 2 to 2000,

R is as previously defined,

X represents a carbonyl or NR unit with R′ representing a hydrogen atom or a C₁ to C₆ alkyl radical,

Y represents a unit

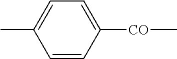

of which the carbonyl function is bonded to A,

A represents:
a radical of formula NR₁(R₂)CO— with:
   R₂ representing a linear or branched, polymeric or non-polymeric, at least C₂ hydrocarbon-based chain, where appropriate interrupted with one or more heteroatoms such as oxygen, sulfur or nitrogen atoms or a cyclic, saturated or unsaturated or aromatic diyl radical preferably in the para-position, and
   R₁ representing a hydrogen atom or an acyclic or cyclic C₁ to C₆ alkyl radical, where appropriate substituted, in particular with a halogen atom, an acyl radical, an aryl radical, an aralkyl radical or a heterocycle, or
a radical of formula —NH(R″)NH—, —CO(R″)CO—, —O(R″)O— or —S(R″)S—, with R″ representing a linear or branched, saturated or unsaturated, polymeric or non-polymeric hydrocarbon-based chain, where appropriate interrupted with one or more heteroatoms, preferably oxygen, nitrogen or sulfur atoms, or an aryl or aralkyl radical, and

B represents a carbonyl or —NR′— unit with R′ representing a hydrogen atom or a C₁ to C₆ alkyl radical with B being capable of forming a bonding group with the end function of a unit A.

According to one preferred variant, the polymer according to the invention comprises at least one structural entity of formula (II) corresponding to formula (IIa):

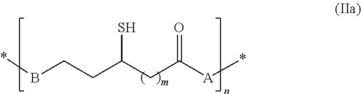

in which:

n, m and B are as defined above, and

A represents:
a radical of formula NH(R₂)CO with R₂ representing a linear or branched C₂ to C₁₀ hydrocarbon-based chain, where appropriate interrupted with one or more heteroatoms such as oxygen, sulfur or nitrogen atoms,
a radical of formula NH(R″)NH with R″ representing a linear or branched, saturated or unsaturated, polymeric or non-polymeric, C₂ to C₁₀ hydrocarbon-based chain, where appropriate interrupted with one or more heteroatoms, preferably oxygen, nitrogen or sulfur atoms.

According to a second implementation variant, at least one unit of formula (I) is present in the polymer according to the invention in the form of a structural entity of formula (III):

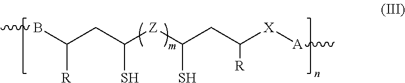

in which:

n, m, B, X and R are as defined above,

A represents:
a radical of formula —NR₁(R′)NR₂— with R′ representing a linear or branched, polymeric or non-polymeric, at least C₂ hydrocarbon-based chain, where appropriate interrupted with one or more heteroatoms such as oxygen, sulfur or nitrogen atoms or a cyclic, saturated, unsaturated or aromatic diyl radical, preferably in the para-position, and R₁ and R₂ represent, independently of one another, a hydrogen atom or an acyclic or cyclic C₁ to C₆ alkyl radical, where appropriate substituted, in particular with a halogen atom, an acyl radical, an aryl radical, an aralkyl radical or a heterocycle;
a heterocyclic diyl radical which may be chosen from piperazinyl, 1,3,4,5-tetrahydroimidazolyl, 1,4-diazepanyl or 1,5-diazocanyl radicals,
a radical of formula —CO(R″)CO—, —O(R″)O— or —S(R″)S— with R″ representing a linear or branched, saturated or unsaturated, polymeric or non-polymeric hydrocarbon-based chain, where appropriate interrupted with one or more heteroatoms, preferably oxygen, nitrogen or sulfur atoms, or an aryl or aralkyl radical, and

Z represents:
a saturated or unsaturated C₁ to C₂₀ hydrocarbon-based unit, where appropriate interrupted with:
one or more heteroatoms such as oxygen, sulfur or nitrogen atoms, and preferably one or more oxygen atoms,
one or more divalent groups chosen from —NR′— with R′ being a hydrogen atom or a C₁ to C₆ alkyl radical, where appropriate substituted with an SH function, and/or
an aryl diyl radical, in particular phenyl, or

a hydrocarbon-based or silicone-based polymeric chain, where appropriate interrupted with one or more heteroatoms such as oxygen, sulfur or nitrogen atoms and preferably one or more oxygen atoms, in particular of the polyalkylene glycol type, and in particular a chain of the polyethylene glycol or polysiloxane type.

According to one preferred variant, the entity of formula (III) is of formula (IIa):

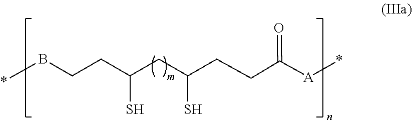

in which:

n, m and B are as defined above, and

A represents:
a radical of formula —NR₁(R′)NR₂— with R′ representing a linear or branched C₂ to C₁₀ hydrocarbon-based chain, where appropriate interrupted with one or more heteroatoms such as oxygen, sulfur or nitrogen atoms or a cyclic, saturated, unsaturated or aromatic diyl radical, preferably in the para-position, and R₁ and R₂ representing, independently of one another, a hydrogen atom or an acyclic or cyclic C₁ to C₆ alkyl radical, where appropriate substituted, in particular with a halogen atom, an acyl radical, an aryl radical, an aralkyl radical or a heterocycle, or
a heterocyclic diyl radical which may be chosen from piperazinyl, 1,3,4,5-tetrahydroimidazolyl, 1,4-diazepanyl and 1,5-diazocanyl radicals.

According to one particular embodiment, R represents a hydrogen atom in formulae (II) and (III).

According to one particular embodiment, A represents, in formula (II) or (IIa) a radical of formula —NH(R′)NH— or of formula —NH(R₂)CO— with R′ and R₂ representing a linear or branched, polymeric or non-polymeric, at least C₂ hydrocarbon-based chain, where appropriate interrupted with one or more oxygen atoms, and B represents NH when A represents —NH(R₂)CO— and CO when A represents —NH(R′)NH—.

In particular, when A represents an —NH(R₂)CO— radical, R₂ represents therein a linear or branched C₂ to C₁₀ hydrocarbon-based chain, where appropriate interrupted with one or more heteroatoms such as oxygen, sulfur or nitrogen atoms.

According to one particular embodiment, A represents, in formula (III) or (IIa), a heterocyclic diyl radical and more particularly a piperazinyl diyl radical.

By way of nonlimiting illustration of the polymeric structures or specific compounds which are in accordance with the invention since they have at least one unit of formula (I), or even in accordance with entity subformula (II), (IIa), (III) or (IIa), mention may in particular be made of the structures which follow:

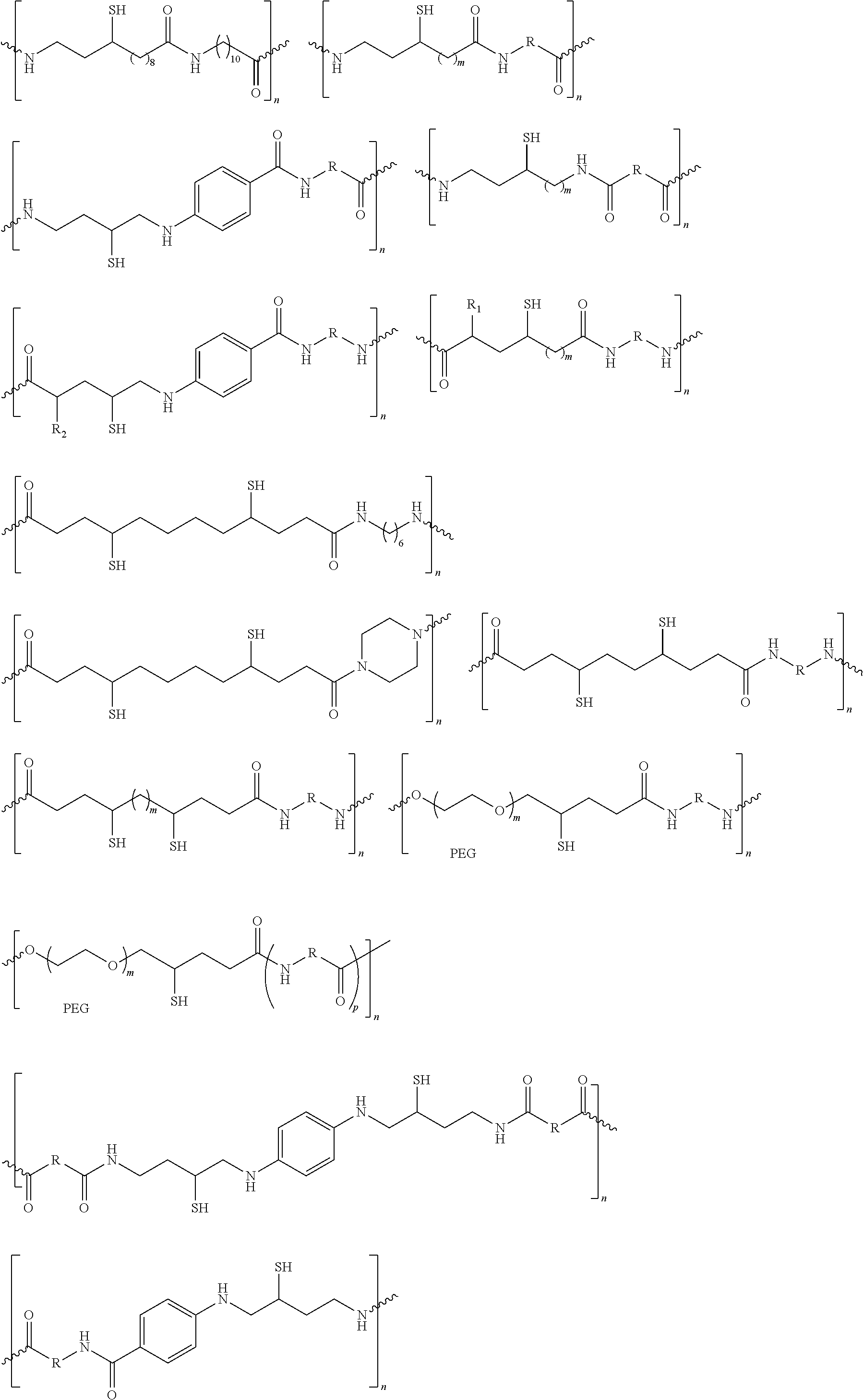

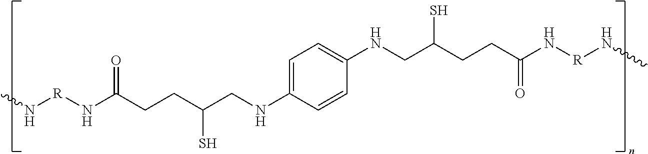

with:

R₁ being in accordance with the definition of R in formulae (II) and (III),

R being in accordance with the definition of R₂ in —NR₁(R₂)CO— or of R″ in NH(R″)NH, proposed for A in formula (II), and

m and n being as defined in formulae (II) and (III).

More particularly, a polymer according to the invention may comprise at least one structural entity chosen from the formulae:

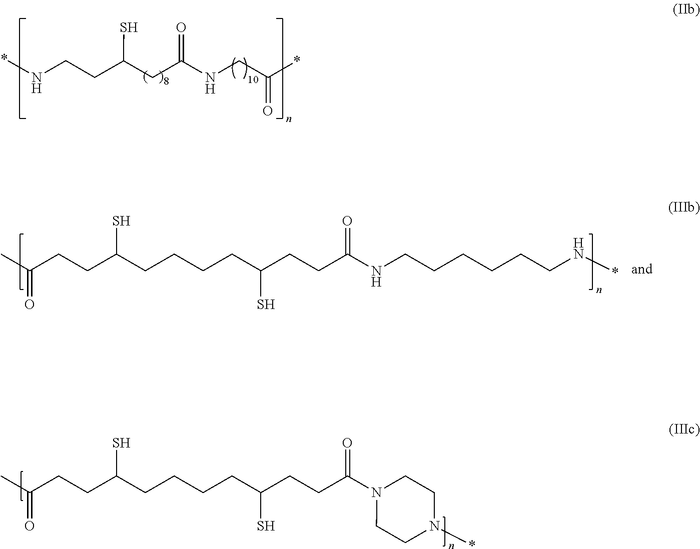

in which n is as defined above.

According to one embodiment, a polymer according to the invention may comprise at least one structural entity of formula (IIb):

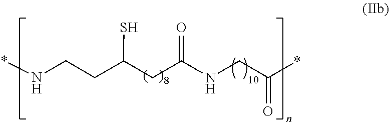

in which n is as defined above.

According to one embodiment, the entity (III) according to the invention is of formula (IIIb):

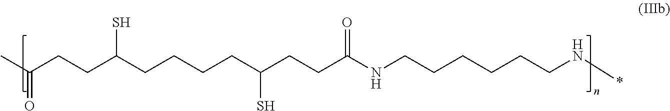

in which n is as defined above.

According to one embodiment, the entity (III) according to the invention is of formula (IIIc):

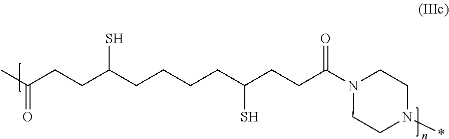

in which n is as defined above.

The synthesis of the polymers according to the invention, and in particular of the structural entities of formula (II), (IIa), (III) or (IIIa), falls within the competence of those skilled in the art.

A polymer according to the invention may thus derive from the copolymerization of molecules of a precursor of one of the entities of formula (II), (IIa), (III) or (IIa) with at least one distinct monomer.

Advantageously, the precursor form corresponds to the monomeric form of one of the entities of formula (II), (IIa), (III) or (IIa), that is to say in which the index “n” is equal to 1.

For the purposes of the present invention, a monomer is a precursor of an entity of formula (II), (IIa), (III) or (IIa) insofar as its condensation, advantageously its copolymerization, with a distinct monomer result, directly or indirectly, in an oligomer and preferably in a polymer formed essentially of an entity of formula (II), (IIa), (III) or (IIa) in which the index “n” is an integer greater than 1 and preferably has a value representative of an oligomer or polymer.

For example, polymers which reproduce the structure of an oligomeric or polymeric entity of formula (II) or (IIa) may be obtained by copolymerization of at least one monomer of formula (IV):

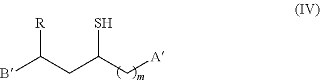

in which:
R and m are as defined above in formula (II),
B′ and A′ represent respectively a radical chosen from a carboxylic and amine function,
   with at least one monomer chosen from H₂NRCO₂H, HCO₂RCO₂H and H₂NRNH₂, in which R represents a linear or branched, polymeric or non-polymeric, at least C₂ hydrocarbon-based chain, where appropriate interrupted with one or more heteroatoms such as oxygen, sulfur or nitrogen atoms.

With regard to the monomers of formula (IV), they may be prepared beforehand according to the technique described in S. Zard et al. (Organic Letters; 2008, Vol. 10, p. 3 279).

As regards polymers which reproduce the structure of an oligomeric or polymeric entity of formula (III) or (IIa), they may in particular be obtained by copolymerization of at least one monomer of formula (V):

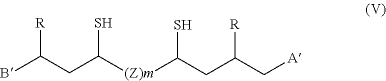

in which:

R, Z and m are as defined above in formula (III),

B′ and A′ are as defined in formula (IV),

with at least one monomer chosen from H₂N—R—CO₂H and H₂N—R—NH₂, in which R represents a linear or branched, polymeric or non-polymeric, at least C₂ hydrocarbon-based chain, where appropriate interrupted with one or more heteroatoms such as oxygen, sulfur or nitrogen atoms.

A subject of the present invention is also a compound of formula (V):

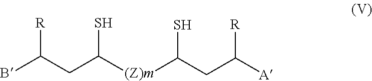

in which:
R represents:

a hydrogen atom,

a linear or branched, saturated or unsaturated C₁ to C₆ hydrocarbon-based radical, where appropriate substituted with one or more halogen atoms,

a C₅ to C₆ aryl radical, or

an acyl, acyloxy, alkoxycarbonyl or cyano radical,

Z represents:
a saturated or unsaturated C₁ to C₂₀ hydrocarbon-based unit, where appropriate interrupted with:
   one or more heteroatoms such as oxygen, sulfur or nitrogen atoms and preferably one or more oxygen atoms,
   one or more divalent groups chosen from NR′ with R′ possibly being a hydrogen atom or a C₁ to C₆ alkyl radical, where appropriate substituted with an SH function, and/or
   an aryl diyl radical, in particular phenyl, or
a hydrocarbon-based or silicone-based polymeric chain, where appropriate interrupted with one or more heteroatoms such as oxygen, sulfur or nitrogen atoms and preferably one or more oxygen atoms, in particular of polyalkylene glycol type, and in particular a chain of polyethylene glycol or polysiloxane type,

m is an integer ranging from 1 to 14 and preferably equal to 1 or 8, and

B′ and A′ represent respectively a radical chosen from a carboxylic and amine function,

in particular as a synthesis intermediate for a polymer in accordance with the invention and in particular comprising at least one entity of formula (III) or (IIa).

Unexpectedly, the inventors have also noted that polymers which reproduce the structure of an oligomeric or polymeric entity of formula (III) or (IIa) are also accessible via the copolymerization of at least one monomer of formula (VI):

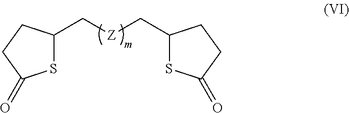

in which Z and m are as defined in formula (III).

The inventors have also noted that polymers which reproduce the structure of an oligomeric or polymeric entity of formula (III) or (IIa) are also accessible via the copolymerization of at least one monomer of formula (VII):

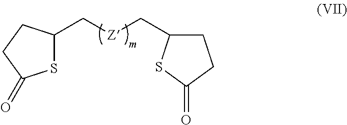

in which:

Z′ represents:
a saturated or unsaturated C₁ to C₂₀ hydrocarbon-based unit, where appropriate interrupted with:
one or more heteroatoms such as oxygen, sulfur or nitrogen atoms and preferably one or more oxygen atoms,
one or more divalent groups chosen from NW with R′ being a hydrogen atom or a C₁ to C₆ alkyl radical, where appropriate substituted with an SH function, and/or
an aryl diyl radical, in particular phenyl,

a saturated or unsaturated C₁ to C₂₀ hydrocarbon-based unit, where appropriate interrupted with one or more heteroatoms such as oxygen, sulfur or nitrogen atoms and preferably one or more oxygen atoms, and substituted with one or more R₁ groups, R₁ representing a saturated or unsaturated C₁ to C₂₀ hydrocarbon-based unit, where appropriate interrupted with one or more heteroatoms such as oxygen, sulfur or nitrogen atoms and preferably one or more oxygen atoms, and possibly being optionally substituted with one or more γ-thiolactone groups,

one or more divalent groups chosen from —NR″— with R″ being a hydrogen atom, a γ-thiolactone group or a C₁ to C₆ alkyl radical, where appropriate substituted with a γ-thiolactone group,

an —NR′-aryl-NR′— radical, and in particular —NR′-phenyl-NR′— radical, with R′ being as defined above,

an —O-aryl-O— radical, and in particular —O-phenyl-O— radical, the aryl radical, and in particular phenyl radical, being optionally substituted with one or more R₁ groups, R₁ being as defined above, or

a hydrocarbon-based or silicone-based polymeric chain, where appropriate interrupted with one or more heteroatoms such as oxygen, sulfur or nitrogen atoms and preferably one or more oxygen atoms, in particular of the polyalkylene glycol type and, in particular, a chain of the polyethylene glycol or polysiloxane type,

m is an integer ranging from 0 to 14, in particular from 1 to 14, and preferably equal to 1 or 8.

Preferably, in the monomer of formula (VII):

Z′ represents:

a saturated or unsaturated C₁ to C₂₀ hydrocarbon-based unit, where appropriate interrupted with:
one or more heteroatoms such as oxygen, sulfur or nitrogen atoms and preferably one or more oxygen atoms,
one or more divalent groups chosen from —NR′— with R′ being a hydrogen atom or a C₁ to C₆ alkyl radical, where appropriate substituted with an —SH function, and/or
an aryl diyl radical, in particular phenyl, or

a hydrocarbon-based or silicone-based polymeric chain, where appropriate interrupted with one or more heteroatoms such as oxygen, sulfur or nitrogen atoms and preferably one or more oxygen atoms, in particular of the polyalkylene glycol type and, in particular, a chain of the polyethylene glycol or polysiloxane type,

m is an integer ranging from 1 to 14 and preferably equal to 1 or 8.

Preferably, a monomer of formula (VII) may be chosen from the following compounds:

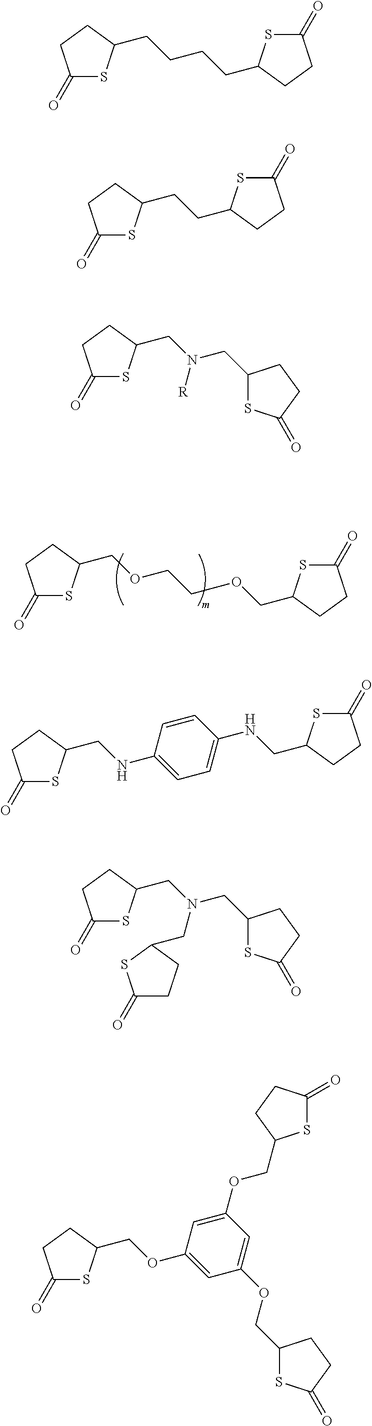

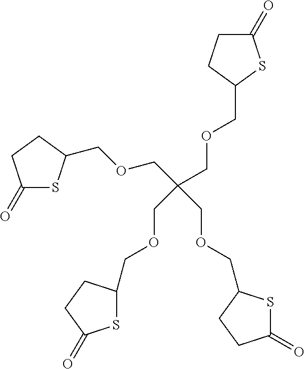 [SMILES: O=C1CCC(COCC(COCC2CCC(=O)S2)(COCC2CCC(=O)S2)COCC2CCC(=O)S2)S1]

The monomers of formula (VII) may be in particular obtained according to the following preparation process: after radical addition of an alkyl acetate xanthate to a molecule bearing double bonds at the end of the chains, using a peroxide as initiator, the addition product is saponified in a basic medium so as to obtain a molecule having, as ending, one or more carboxylic acids and one or more SH functions in ω-4. This intermediate is then placed in a cyclization condition in the presence of acid in catalytic amount so as to give one or more chain-end thiolactone functions.

Advantageously, the monomers of formula (VII) as defined above may be particularly of use as a reagent with nucleophilic compounds.

Thus, according to another of its aspects, the invention relates to a process for preparing a compound of formula (III) according to the invention, comprising the condensation or copolymerization of at least one molecule of formula (VI) or (VII) as defined above, with at least one monomer chosen from H₂N—R—CO₂H and H₂N—R—NH₂, in which R represents a linear or branched, polymeric or non-polymeric, at least C₂ hydrocarbon-based chain, where appropriate interrupted with one or more heteroatoms such as oxygen, sulfur or nitrogen atoms.

This original synthesis is in particular illustrated in the examples hereinafter.

As previously specified, the polymers according to the invention are particularly advantageous for their properties in terms of adhesion which advantageously prove to be modulable.

Indeed, it is the proportion of units of formula (I) in the polymer which will contribute to its tackifying performance levels. A low proportion of units of formula (I) may contribute to forming a removable coating. Conversely, a high proportion generally contributes to forming an unremovable coating.

Thus, a polymer according to the invention may have a weight proportion of units of formula (I) ranging from 1% to 90% relative to its total weight.

This proportion of units of formula (I) may thus be modulated during the copolymerization of the monomers dedicated to forming the structural entity of formulae (II), (IIa), (III) and (IIa) by adjusting the proportion of the various monomers brought into contact.

However, a polymer according to the invention may also derive from the condensation or copolymerization of at least one precursor of an entity of formula (II), (IIa), (III) or (IIa) in which the index “n” advantageously has a value other than 1 and preferably has a value representative of an oligomer or polymer with at least one secondary and distinct polymeric chain.

Thus, according to one embodiment, a polymer according to the invention may be formed of at least one entity of formula (II) or (IIa) defined above and/or of an entity of formula (III) or (IIa) defined above in a form condensed, in particular by copolymerization, to at least one distinct secondary polymeric chain of said entity.

The secondary polymeric chain may be chosen from polyamides, polyethers, silicone-based chains, polyamines and polysulfides.

This condensation has the effect of conferring, on the polymeric chain under consideration, either tackifying properties if it is devoid thereof, or a gain in terms of adhesion if it already has tackifying properties.

Thus, according to one of its aspects, a subject of the present invention is also a process which is of use for modulating the adhesion properties of a polymer, comprising bringing said polymer into contact with at least one precursor of an entity of formula (II), (IIa), (III) or (IIa) in which the index “n” advantageously has a value other than 1 and preferably has a value representative of an oligomer or polymer, under conditions suitable for the condensation and in particular for the copolymerization of said precursor with said polymer to be treated.

As previously specified, the present invention is also directed toward a composition for coating comprising at least one polymer in accordance with the invention.

It also relates to a support comprising, at the surface, at least one coating deriving from a polymer according to the invention.

Such a coating may in particular be obtained by means of a process comprising at least bringing the surface to be treated of said support into contact with at least one polymer according to the invention and exposing said polymer in contact with said support to conditions suitable for its conversion into a coating.

These conditions may vary according to the chemical nature of the polymer or even that of the support. They are generally effective for causing the crosslinking of said polymer and the establishment of covalent or non-covalent bonds between the coating thus formed and the support. In the context of the present invention, the SH functions present in the coating specifically contribute effectively to immobilizing this coating at the surface of the support. This phenomenon is in particular verified in the examples presented hereinafter.

The invention is also directed toward a support surface-treated with a coating deriving totally or partly from a polymer according to the invention.

The examples which appear hereinafter are presented by way of nonlimiting illustration of the field of the invention.

### Example 1

### Synthesis of 12-amino-10-mercaptododecanoic acid

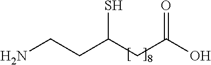

40 ml of hydrazine are added to a solution of 80 g of 12-(1,3-dioxoisoindolin-2-yl)-10-((ethoxycarbonothioyl)thio)dodecanoic acid (Ref: S. Zard et al. Organic Letters; 2008, Vol. 10, p. 3 279) in solution in 400 ml of ethanol. The reaction mixture is stirred for 48 hours at ambient temperature. The solvent is then evaporated off. The crude solid obtained is washed with diethyl ether, then recrystallized from methanol.

### Example 2

### Synthesis of 5,5′-(butane-1,4-diyl)bis(dihydrothiophen-2(3H)-one)

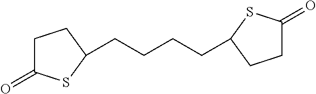 [SMILES: O=C1CCC(CCCCC2CCC(=O)S2)S1]

### Step A: Synthesis of diethyl 4,9-bis((ethoxycarbonothioyl)thio)dodecanedioate

A mixture of 15 g of ethyl 2-((ethoxycarbonothioyl)thio)acetate and 5 ml of 1,7-octadiene is stirred for 15 min at 125° C. under a nitrogen atmosphere.

1.5 ml of di-tert-butyl peroxide are then added and the reaction mixture is stirred at 125° C. for 2 hours under a nitrogen atmosphere. 1.5 ml of di-tert-butyl peroxide are then again added to the reaction mixture.

2 hours after the second addition of peroxide, the by-products are evaporated off and the reaction crude obtained is used without other purification for the next step.

### Step B: Synthesis of 4,9-dimercaptododecanedioic acid

18 g of the crude mixture obtained at the end of step A is dissolved in 100 ml of ethanol. 100 ml of water are then added. The solution is then degassed by bubbling nitrogen for 10 min. 15 g of sodium hydroxide are then added and the reaction mixture is stirred for 2 hours at 60° C.

The ethanol is then partially evaporated off, and the basic aqueous phase is extracted with diethyl ether and then acidified to pH=1 by adding concentrated hydrochloric acid. The acidic aqueous phase is then extracted several times with diethyl ether.

The combined organic phases are dried over magnesium sulfate, then filtered and evaporated to give 11 g of a brown oil that will be used without other purification for the next step.

### Step C: Synthesis of 5,5′-(butane-1,4-diyl)bis(dihydrothiophen-2(3H)-one)

11 g of the crude mixture obtained at the end of step B are dissolved in 100 ml of diethyl ether. 10 drops of concentrated sulfuric acid are then added and the mixture is stirred at the reflux of diethyl ether for 2 hours. 10 other drops of concentrated sulfuric acid are added and the mixture is stirred at the reflux of diethyl ether until total conversion is obtained.

The diethyl ether is then evaporated off and the crude obtained is chromatographed on silica gel with a 1:1 mixture of petroleum ether and diethyl ether as eluents. The 8 g of solid obtained are recrystallized from ethanol to give 5 g of a white solid.

### Example 3

### Synthesis of 5,5′-(ethane-1,2-diyl)bis(dihydrothiophen-2(3H)-one)

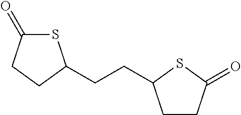 [SMILES: O=C1CCC(CCC2CCC(=O)S2)S1]

Step A: Synthesis of diethyl diethyl 4,7-bis((ethoxycarbonothioyl)thio)-decanedioate

A solution of 10 g of ethyl 2-((ethoxycarbonothioyl)thio)acetate and 1.90 ml of 1,5-hexadiene in 50 ml of ethyl acetate is stirred for 10 min at reflux under a nitrogen atmosphere.

1 g of dilauroyl peroxide is then added and the reaction mixture is stirred at reflux for 1 hour and 30 minutes under a nitrogen atmosphere. Two times 1 g of dilauroyl peroxide are further added every 90 minutes.

2 hours after the final addition of peroxide, the reaction mixture is evaporated to dryness and the reaction crude obtained is used without other purification for the next step.

### Step B: Synthesis of 4,7-dimercaptodecanedioic acid

14 g of the crude mixture obtained at the end of step A are dissolved in 100 ml of ethanol. 100 ml of water are then added. The solution is then degassed by bubbling nitrogen for 10 minutes. 9.6 g of sodium hydroxide are then added and the reaction mixture is stirred for 2 hours at 60° C.

The ethanol is partially evaporated off, and the basic aqueous phase is extracted with diethyl ether and then acidified to pH=1 by adding concentrated hydrochloric acid. The acidic aqueous phase is then extracted several times with diethyl ether.

The combined organic phases are dried over magnesium sulfate, then filtered and evaporated to give 7 g of a brown oil that will be used without other purification in the next step.

### Step C: Synthesis of 5,5′-(ethane-1,2-diyl)bis(dihydrothiophen-2(3H)-one)

7 g of the crude mixture obtained in stage B are dissolved in 100 ml of diethyl ether. 20 drops of concentrated sulfuric acid are then added and the mixture is stirred at reflux of diethyl ether for 4 hours.

The diethyl ether is then evaporated off and the crude obtained is chromatographed on silica gel with a 1:1 mixture of petroleum ether and diethyl ether as eluents. The 4 g of solid obtained are recrystallized from ethanol to give 3 g of a white solid.

### Example 4

### Synthesis of the C₁₁-C₁₂(SH) copolymer

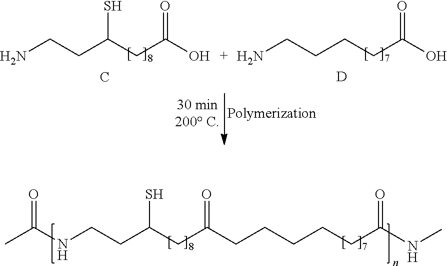

100 mg of C+D containing various percentages of B and C are stirred in a glass tube at a temperature of 200° C. for 30 minutes under a nitrogen stream. The solid formed is then demolded under cold conditions. The melting point of the various copolymers obtained is measured.

| | Melting | Polymerization in a glass |
|---|---|---|
| % C | Point ° C. | tube at 200° C. for 30 minutes |
| 0% | 186° C. | White solid which demolds from the glass tube |
| 1% | 193-195° C. | White solid which demolds from the glass tube |
| 2% | 193-195° C. | White solid which demolds from the glass tube |
| 5% | 195-200° C. | White solid which demolds from the glass tube |
| 10% | does not melt at | Solid which begins to stick to the walls |
| | 300° C. | of the tube |
| 20% | does not melt at | Solid which begins to stick to the walls |
| | 300° C. | of the tube |
| 30% | does not melt at | Solid which begins to stick to the walls |
| | 300° C. | of the tube |
| 100% | does not melt at | Solid which begins to stick to the walls |
| | 300° C. | of the tube |

### Example 5

### Synthesis of the polyamide PA6-12(2SH) copolymer

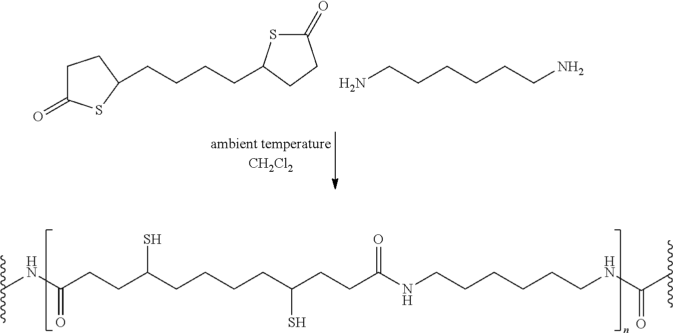

550 mg of 1,6-hexanediamine are added to 1 g of 5,5′-(butane-1,4-diyl)bis(dihydrothiophen-2(3H)-one) in solution in 20 ml of dichloromethane. The mixture is stirred at ambient temperature for 24 hours. The solvent is then evaporated off and 1.550 g of a beige-colored solid are obtained.

This solid is placed on a metal plate heated to 200° C., then a glass plate is applied above for 30 seconds.

The device is left to cool to ambient temperature for 24 hours. The glass has adhered well to the metal and cannot be removed by a manual tensile force.

### Example 6

### Synthesis of the polyamide PA piperazine-12(2S) copolymer

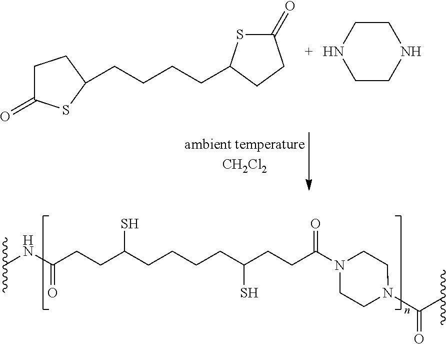

335 mg of piperazine are added to 1 g of 5,5′-(butane-1,4-diyl)bis(dihydrothiophen-2(3H)-one) in solution in 20 ml of dichloromethane. The mixture is stirred at reflux for 1 hour. The solvent is then evaporated off and 1.3 g of a honey-colored sticky gum are obtained.

1. A polymer having adhesion properties, comprising at least one consecutive or non-consecutive structural unit of formula (I): 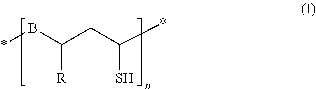
in which:
B represents a carbonyl or —NR′— unit with R′ representing a hydrogen atom, a C₁ to C₆ alkyl radical, or a C₅ to C₆ aryl, carbamate or acyl radical; and
R represents:
a hydrogen atom,
a linear or branched, saturated or unsaturated C₁ to C₆ hydrocarbon-based radical which is optionally substituted with one or more halogen atoms,
a C₅ to C₆ aryl radical, or
an acyl, acyloxy, alkoxycarbonyl or cyano radical.

2. The polymer as claimed in claim 1, comprising an effective amount of units of formula (I) to confer thereon a tackifying property.

3. The polymer as claimed in claim 1, wherein a weight proportion of units of formula (I) ranges from 1% to 90% relative to its total weight.

4. The polymer as claimed in claim 1, wherein the units of formula (I) are not present therein in a contiguous manner.

5. The polymer as claimed in claim 1, wherein said unit of formula (I) is present in said polymer in the form of a structural entity, of optionally polymeric or oligomeric nature.

6. The polymer as claimed in claim 1, comprising at least one entity of formula (II): 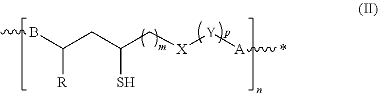
in which:
m is an integer ranging from 1 to 14,
p is equal to zero or 1,
n is an integer representative of an oligomeric or polymeric sequence,
R represents:
a hydrogen atom,
a linear or branched, saturated or unsaturated C₁ to C₆ hydrocarbon-based radical which is optionally substituted with one or more halogen atoms,
a C₅ to C₆ aryl radical, or
an acyl, acyloxy, alkoxycarbonyl or cyano radical
X represents a carbonyl or —NR′— unit with R′ representing a hydrogen atom or a C₁ to C₆ alkyl radical,
Y represents a unit 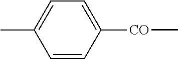
of which the carbonyl function is bonded to A,
A represents:
a radical of formula NR₁(R₂)CO— with:
R₂ representing a linear or branched, polymeric or non-polymeric, at least C₂ hydrocarbon-based chain, where appropriate interrupted with one or more heteroatoms or a cyclic, saturated or unsaturated or aromatic diyl radical, and
R₁ representing a hydrogen atom or an acyclic or cyclic C₁ to C₆ alkyl radical, where appropriate substituted with a halogen atom, an acyl radical, an aryl radical, an aralkyl radical or a heterocycle, or
a radical of formula —NH(R″)NH—, —CO(R″)CO—, —O(R″)O— or —S(R″)S—, with R″ representing a linear or branched, saturated or unsaturated, polymeric or non-polymeric hydrocarbon-based chain, where appropriate interrupted with one or more heteroatoms, or an aryl or aralkyl radical, and
B represents a carbonyl or —NR′— unit with R′ representing a hydrogen atom or a C₁ to C₆ alkyl radical with B being capable of forming a bonding group with the end function of a unit A.

7. The polymer as claimed in claim 6, wherein the entity of formula (II) corresponds to formula (IIa): 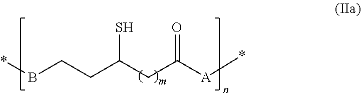
in which:
n is an integer representative of an oligomeric or polymeric sequence,
m is an integer ranging from 1 to 14,
B represents a carbonyl or —NR′— unit with R′ representing a hydrogen atom or a C₁ to C₆ alkyl radical with B being capable of forming a bonding group with the end function of a unit A, and
A represents:
a radical of formula —NH(R₂)CO— with R₂ representing a linear or branched C₂ to C₁₀ hydrocarbon-based chain, where appropriate interrupted with one or more heteroatoms,
a radical of formula —NH(R″)NH— with R″ representing a linear or branched, saturated or unsaturated, polymeric or non-polymeric, C₂ to C₁₀ hydrocarbon-based chain, where appropriate interrupted with one or more heteroatoms.

8. The polymer as claimed in claim 1, comprising at least one entity of formula (IIb): 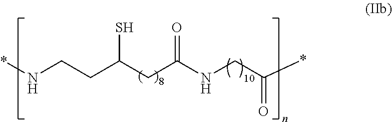
in which n is as defined in claim 6.

9. The polymer as claimed in claim 1, comprising at least one entity of formula (III): 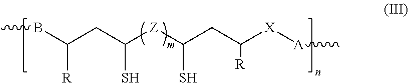
in which:
n is an integer representative of an oligomeric or polymeric sequence,
m is an integer ranging from 1 to 14,
B represents a carbonyl or —NR′— unit with R′ representing a hydrogen atom or a C₁ to C₆ alkyl radical with B being capable of forming a bonding group with the end function of a unit A,
X represents a carbonyl or —NR′— unit with R′ representing a hydrogen atom or a C₁ to C₆ alkyl radical,
R represents:
a hydrogen atom,
a linear or branched, saturated or unsaturated C₁ to C₆ hydrocarbon-based radical which is optionally substituted with one or more halogen atoms,
a C₅ to C₆ aryl radical, or
an acyl, acyloxy, alkoxycarbonyl or cyano radical
A represents:
a radical of formula —NR₁(R′)NR₂— with R′ representing a linear or branched, polymeric or non-polymeric, at least C₂ hydrocarbon-based chain, where appropriate interrupted with one or more heteroatoms or a cyclic, saturated, unsaturated or aromatic diyl radical, and R₁ and R₂ represent, independently of one another, a hydrogen atom or an acyclic or cyclic C₁ to C₆ alkyl radical, where appropriate substituted with a halogen atom, an acyl radical, an aryl radical, an aralkyl radical or a heterocycle,
a heterocyclic diyl radical which may be chosen from piperazinyl, 1,3,4,5-tetrahydroimidazolyl, 1,4-diazepanyl or 1,5-diazocanyl radicals,
a radical of formula —CO(R″)CO—, —O(R″)O— or —S(R″)S— with R″ representing a linear or branched, saturated or unsaturated, polymeric or non-polymeric hydrocarbon-based chain, where appropriate interrupted with one or more heteroatoms, or an aryl or aralkyl radical, and
Z represents:
a saturated or unsaturated C₁ to C₂₀ hydrocarbon-based unit, where appropriate interrupted with:
one or more heteroatoms,
one or more divalent groups chosen from —NR′— with R′ being a hydrogen atom or a C₁ to C₆ alkyl radical, where appropriate substituted with an —SH function, and/or
an aryl diyl radical, or
a hydrocarbon-based or silicone-based polymeric chain, where appropriate interrupted with one or more heteroatoms.

10. The polymer as claimed in claim 9, wherein the entity of formula (III) is of formula (IIIa): 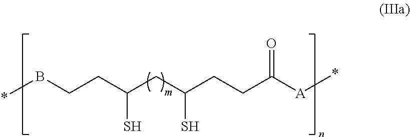
in which:
n, m and B are as defined in claim 9, and
A represents:
a radical of formula —NR₁(R′)NR₂— with R′ representing a linear or branched C₂ to C₁₀ hydrocarbon-based chain, where appropriate interrupted with one or more heteroatoms or a cyclic, saturated, unsaturated or aromatic diyl radical, and R₁ and R₂ representing, independently of one another, a hydrogen atom or an acyclic or cyclic C₁ to C₆ alkyl radical, where appropriate substituted with a halogen atom, an acyl radical, an aryl radical, an aralkyl radical or a heterocycle, or
a heterocyclic diyl radical which may be chosen from piperazinyl, 1,3,4,5-tetrahydroimidazolyl, 1,4-diazepanyl and 1,5-diazocanyl units.

11. The polymer as claimed in claim 9, wherein the entity (III) is of formula (IIIb): 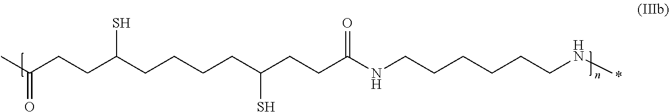
in which n is an integer representative of an oligomeric or polymeric sequence.

12. The polymer as claimed in claim 9, wherein the entity (III) is of formula (IIIc): 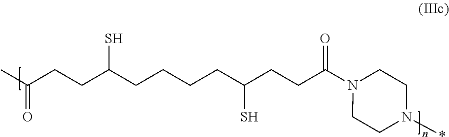
in which n is an integer representative of an oligomeric or polymeric sequence.

13. The polymer as claimed in claim 1, comprising at least one entity of formula (II): 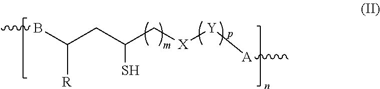
in which:
m is an integer ranging from 1 to 14,
p is equal to zero or 1,
n is an integer representative of an oligomeric or polymeric sequence,
R represents:
a hydrogen atom,
a linear or branched, saturated or unsaturated C₁ to C₆ hydrocarbon-based radical which is optionally substituted with one or more halogen atoms,
a C₅ to C₆ aryl radical, or
an acyl, acyloxy, alkoxycarbonyl or cyano radical
X represents a carbonyl or —NR′— unit with R′ representing a hydrogen atom or a C₁ to C₆ alkyl radical,
Y represents a unit 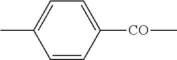
of which the carbonyl function is bonded to A,
A represents:
a radical of formula —NR₁(R₂)CO— with:
R₂ representing a linear or branched, polymeric or non-polymeric, at least C₂ hydrocarbon-based chain optionally interrupted with one or more heteroatoms or a cyclic, saturated or unsaturated or aromatic diyl radical, and
R₁ representing a hydrogen atom or an acyclic or cyclic C₁ to C₆ alkyl radical optionally substituted with a halogen atom, an acyl radical, an aryl radical, an aralkyl radical or a heterocycle, or
a radical of formula —NH(R″)NH—, —CO(R″)CO—, —O(R″)O— or —S(R″)S—, with R″ representing a linear or branched, saturated or unsaturated, polymeric or non-polymeric hydrocarbon-based chain optionally interrupted with one or more heteroatoms, or an aryl or aralkyl radical, and
B represents a carbonyl or —NR′— unit with R′ representing a hydrogen atom or a C₁ to C₆ alkyl radical with B being capable of forming a bonding group with the end function of a unit A,
or an entity of formula (III): 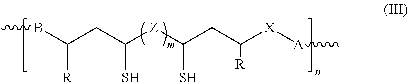
in which:
n is an integer representative of an oligomeric or polymeric sequence,
m is an integer ranging from 1 to 14,
B represents a carbonyl or —NR′— unit with R′ representing a hydrogen atom or a C₁ to C₆ alkyl radical with B being capable of forming a bonding group with the end function of a unit A,
X represents a carbonyl or —NR′— unit with R′ representing a hydrogen atom or a C₁ to C₆ alkyl radical,
R represents:
a hydrogen atom,
a linear or branched, saturated or unsaturated C₁ to C₆ hydrocarbon-based radical which is optionally substituted with one or more halogen atoms,
a C₅ to C₆ aryl radical, or
an acyl, acyloxy, alkoxycarbonyl or cyano radical
A represents:
a radical of formula —NR₁(R′)NR₂— with R′ representing a linear or branched, polymeric or non-polymeric, at least C₂ hydrocarbon-based chain optionally interrupted with one or more heteroatoms or a cyclic, saturated, unsaturated or aromatic diyl radical, and R₁ and R₂ represent, independently of one another, a hydrogen atom or an acyclic or cyclic C₁ to C₆ alkyl radical optionally substituted with a halogen atom, an acyl radical, an aryl radical, an aralkyl radical or a heterocycle,
a heterocyclic diyl radical which may be chosen from piperazinyl, 1,3,4,5-tetrahydroimidazolyl, 1,4-diazepanyl or 1,5-diazocanyl radicals,
a radical of formula —CO(R″)CO—, —O(R″)O— or —S(R″)S— with R″ representing a linear or branched, saturated or unsaturated, polymeric or non-polymeric hydrocarbon-based chain optionally interrupted with one or more heteroatoms, or an aryl or aralkyl radical, and
Z represents:
a saturated or unsaturated C₁ to C₂₀ hydrocarbon-based unit optionally interrupted with:
one or more heteroatoms,
one or more divalent groups chosen from NR with R′ being a hydrogen atom or a C₁ to C₆ alkyl radical optionally substituted with an SH function, and/or
an aryl diyl radical, or
a hydrocarbon-based or silicone-based polymeric chain optionally interrupted with one or more heteroatoms,
in a form condensed, to at least one distinct secondary polymeric chain of said entity.

14. The polymer as claimed in claim 13, wherein the at least one distinct secondary polymeric chain is chosen from polyamides, polyethers, silicone-based chains, polyamines and polysulfides.

15. A composition for coating, comprising at least one polymer as claimed in claim 1.

16. A process for forming a coating at the surface of a support, comprising at least bringing the surface to be treated of said support into contact with a polymer as claimed in claim 1 and exposing said polymer in contact with said support to conditions suitable for converting said polymer in contact with said support into a coating.

17. A support surface-treated with a coating deriving totally or partly from a polymer as claimed in claim 1.

18. A process that is of use for modulating the properties in terms of adhesion of a polymer, comprising bringing said polymer into contact with at least one precursor of an entity of formula (II) 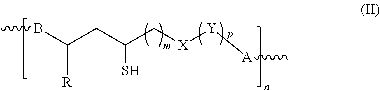
in which:
m is an integer ranging from 1 to 14,
p is equal to zero or 1,
n is an integer representative of an oligomeric or polymeric sequence,
R represents:
a hydrogen atom,
a linear or branched, saturated or unsaturated C₁ to C₆ hydrocarbon-based radical which is optionally substituted with one or more halogen atoms,
a C₅ to C₆ aryl radical, or
an acyl, acyloxy, alkoxycarbonyl or cyano radical
X represents a carbonyl or —NR′— unit with R′ representing a hydrogen atom or a C₁ to C₆ alkyl radical,
Y represents a unit 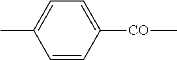
of which the carbonyl function is bonded to A,
A represents:
a radical of formula —NR₁(R₂)CO— with:
R₂ representing a linear or branched, polymeric or non-polymeric, at least C₂ hydrocarbon-based chain optionally interrupted with one or more heteroatoms or a cyclic, saturated or unsaturated or aromatic diyl radical, and
R₁ representing a hydrogen atom or an acyclic or cyclic C₁ to C₆ alkyl radical optionally substituted with a halogen atom, an acyl radical, an aryl radical, an aralkyl radical or a heterocycle, or
a radical of formula —NH(R″)NH—, —CO(R″)CO—, —O(R″)O— or —S(R″)S—, with R″ representing a linear or branched, saturated or unsaturated, polymeric or non-polymeric hydrocarbon-based chain optionally interrupted with one or more heteroatoms, or an aryl or aralkyl radical, and
B represents a carbonyl or —NR′— unit with R′ representing a hydrogen atom or a C₁ to C₆ alkyl radical with B being capable of forming a bonding group with the end function of a unit A,
or (III): 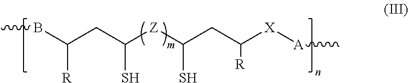
in which:
n is an integer representative of an oligomeric or polymeric sequence,
m is an integer ranging from 1 to 14,
B represents a carbonyl or —NR′— unit with R′ representing a hydrogen atom or a C₁ to C₆ alkyl radical with B being capable of forming a bonding group with the end function of a unit A,
X represents a carbonyl or —NR′— unit with R′ representing a hydrogen atom or a C₁ to C₆ alkyl radical,
R represents:
a hydrogen atom,
a linear or branched, saturated or unsaturated C₁ to C₆ hydrocarbon-based radical which is optionally substituted with one or more halogen atoms,
a C₅ to C₆ aryl radical, or
an acyl, acyloxy, alkoxycarbonyl or cyano radical
A represents:
a radical of formula —NR₁(R)NR₂— with R′ representing a linear or branched, polymeric or non-polymeric, at least C₂ hydrocarbon-based chain, where appropriate interrupted with one or more heteroatoms or a cyclic, saturated, unsaturated or aromatic diyl radical, and R₁ and R₂ represent, independently of one another, a hydrogen atom or an acyclic or cyclic C₁ to C₆ alkyl radical, where appropriate substituted with a halogen atom, an acyl radical, an aryl radical, an aralkyl radical or a heterocycle,
a heterocyclic diyl radical which may be chosen from piperazinyl, 1,3,4,5-tetrahydroimidazolyl, 1,4-diazepanyl or 1,5-diazocanyl radicals,
a radical of formula —CO(R″)CO—, —O(R″)O— or —S(R″)S— with R″ representing a linear or branched, saturated or unsaturated, polymeric or non-polymeric hydrocarbon-based chain, where appropriate interrupted with one or more heteroatoms, or an aryl or aralkyl radical, and
Z represents:
a saturated or unsaturated C₁ to C₂₀ hydrocarbon-based unit, where appropriate interrupted with:
one or more heteroatoms,
one or more divalent groups chosen from —NR′— with R′ being a hydrogen atom or a C₁ to C₆ alkyl radical, where appropriate substituted with an SH function, and/or
an aryl diyl radical, or
a hydrocarbon-based or silicone-based polymeric chain, where appropriate interrupted with one or more heteroatoms,
in which the index “n” advantageously has a value other than 1, under conditions suitable for the condensation of said precursor with said polymer to be treated.

19. A process for preparing a compound of formula (III) as claimed in claim 9, comprising the condensation or copolymerization of at least one molecule of formula (VI): 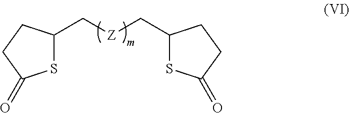
with at least one monomer chosen from H₂N—R—CO₂H and H₂N—R—NH₂ in which R represents a linear or branched, polymeric or non-polymeric, at least C₂ hydrocarbon-based chain, where appropriate interrupted with one or more heteroatoms.

20. A compound of formula (V): 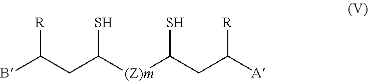
in which:
R represents:
a hydrogen atom,
a linear or branched, saturated or unsaturated C₁ to C₆ hydrocarbon-based radical, where appropriate substituted with one or more halogen atoms,
a C₅ to C₆ aryl radical, or
an acyl, acyloxy, alkoxycarbonyl or cyano radical,
Z represents:
a saturated or unsaturated C₁ to C₂₀ hydrocarbon-based unit, where appropriate interrupted with:
one or more heteroatoms,
one or more divalent groups chosen from NR with R′ possibly being a hydrogen atom or a C₁ to C₆ alkyl radical, where appropriate substituted with an SH function, and/or
an aryl diyl radical, or
a hydrocarbon-based or silicone-based polymeric chain, where appropriate interrupted with one or more heteroatoms,
m is an integer ranging from 1 to 14, and
B′ and A′ represent respectively a radical chosen from a carboxylic and amine function.

21. A compound of formula (VII): 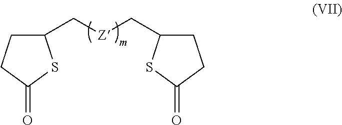
in which:
Z′ represents:
a saturated or unsaturated C₁ to C₂₀ hydrocarbon-based unit, where appropriate interrupted with:
one or more heteroatoms,
one or more divalent groups chosen from —NR′— with R′ being a hydrogen atom or a C₁ to C₆ alkyl radical, where appropriate substituted with an SH function, and/or
an aryl diyl radical,
a saturated or unsaturated C₁ to C₂₀ hydrocarbon-based unit, where appropriate interrupted with one or more heteroatoms, and substituted with one or more R₁ groups, R₁ representing a saturated or unsaturated C₁ to C₂₀ hydrocarbon-based unit, where appropriate interrupted with one or more heteroatoms, and possibly being optionally substituted with one or more γ-thiolactone groups,
one or more divalent groups chosen from —NR″— with R″ being a hydrogen atom, a γ-thiolactone group or a C₁ to C₆ alkyl radical, where appropriate substituted with a γ-thiolactone group,
an —NR′-aryl-NR′— radical, with R′ being as defined above,
an —O-aryl-O— radical, the aryl radical, being optionally substituted with one or more R₁ groups, R₁ being as defined above, or
a hydrocarbon-based or silicone-based polymeric chain, where appropriate interrupted with one or more heteroatoms,
m is an integer ranging from 0 to 14.

22. The compound as claimed in claim 21, wherein:
Z′ represents:
a saturated or unsaturated C₁ to C₂₀ hydrocarbon-based unit, where appropriate interrupted with:
one or more heteroatoms,
one or more divalent groups chosen from —NR′— with R′ being a hydrogen atom or a C₁ to C₆ alkyl radical, where appropriate substituted with an —SH function, and/or
an aryl diyl radical, or
a hydrocarbon-based or silicone-based polymeric chain, where appropriate interrupted with one or more heteroatoms,
m is an integer ranging from 1 to 14.

23. The compound as claimed in claim 21, chosen from the following compounds: 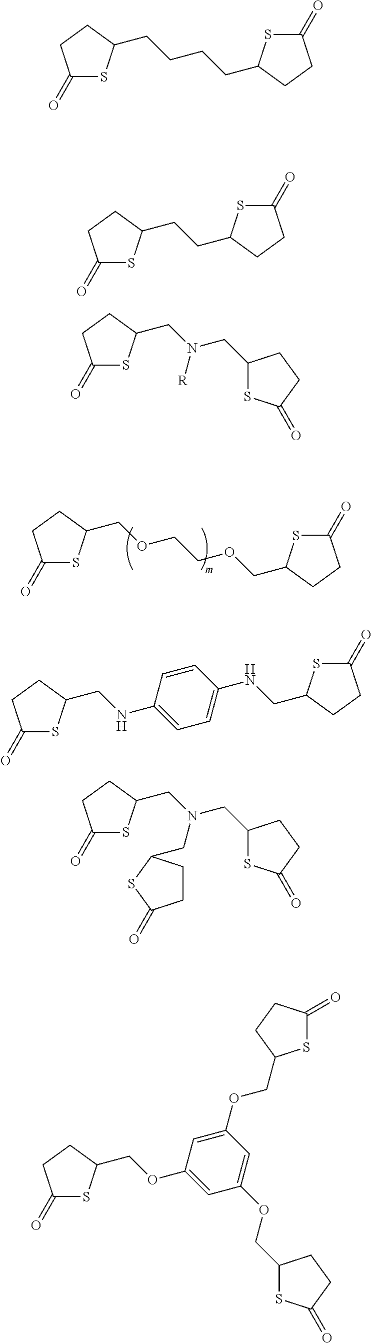 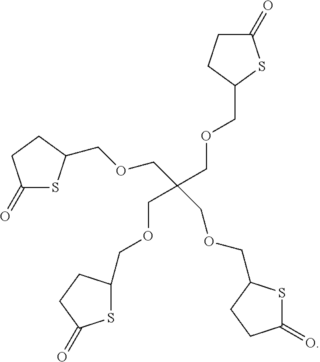 [SMILES: O=C1CCC(COCC(COCC2CCC(=O)S2)(COCC2CCC(=O)S2)COCC2CCC(=O)S2)S1]
